(19) United States
(12) Patent Application Publication
(10) Pub. No.: US 2026/0243045 A1
(43) Pub. Date: Aug. 20, 2026

(54) RETAINING WALL BLOCK AND METHODS FOR MAKING AND INSTALLING SAME

(71) Applicant: Jon Calle, Pottstown, PA (US)

(72) Inventor: Jon Calle, Pottstown, PA (US)

(21) Appl. No.: 19/544,658

(22) Filed: Feb. 19, 2026

Related U.S. Application Data
(60) Provisional application No. 63/760,573, filed on Feb. 19, 2025.

(51) Int. Cl. E02D 29/02; B28B 7/18; B66C 23/36

(52) U.S. Cl. CPC E02D 29/025; B28B 7/183; B66C 23/36; E02D 29/0266; E02D 2250/0007; E02D 2300/002; E02D 2300/0034; E02D 2600/40

(57) ABSTRACT

A retaining wall block includes a through hole for receiving a post that extends through the block and into a pocket formed by the sidewalls of a pair of blocks in a lower row of blocks. A fixture is installed in the pocket for receiving a lowermost end of the post. The posts form a personnel barrier. A mold for forming the blocks includes an optional, removeable divider plate for forming individual blocks or, if the divider plate is omitted, for forming a pair of opposing blocks to enable split faces. A vehicle and corresponding method transporting and assembling retaining wall block includes a crane.

### CROSS-REFERENCE TO RELATED APPLICATIONS

This application claims the benefit of U.S. Provisional Application No. 63/760,573, filed Feb. 19, 2025, the disclosures of which are incorporated herein by reference in their entirety.

### FIELD OF THE INVENTION

The invention relates retaining wall devices and methods. More particularly, the invention relates to retaining wall blocks structures, functions, methods and devices for manufacturing retaining wall blocks, methods and devices for constructing retaining walls, and safety devices and methods for constructing retaining walls.

### BACKGROUND OF THE INVENTION

A retaining wall is a structure that restrains soil between two elevations, often by modifying a steep terrain. Man-made blocks have been used for many years to construct retaining walls. U.S. Pat. No. 6,953,309, titled “Concrete Block With Batter Indicators,” illustrates a conventional retaining wall block, similar to the commercially available Vertica® product.

Many conventional retaining walls employ retaining wall blocks that are stacked in courses without mortar, but retained together by a protrusion on one block that is inserted into a corresponding recess in the block in the course above it. Typically, the protrusion and recess is configured such that a course of wall blocks is offset relative to the course below and such that each block is staggered relative to the blocks below it. The protrusion is sometimes referred to as a “locator.”

Many retaining wall blocks have a front face (that is, the side that is visible upon installation) that is manufactured to have a rough face that resembles the face of natural stone. Others are configured to have a smooth front face.

Conventional retaining wall blocks are manufactured of a concrete or like mix. The term “concrete” is used broadly herein to refer to any concrete or cementitious material employed in modern retaining wall block manufacturing. Typically, to manufacture retaining wall block, a concrete mix is inserted into a mold until set, then the mold is removed. Some molds are configured to form blocks in pairs with the front faces oriented mutually inwardly and molded together such that when the blocks are separated, each front face has a rough texture which can resemble natural stone. The blocks formed in this way have front faces referred to as split faces.

The process of installing retaining wall blocks often begins with laying a few courses, then backfilling with soil, compacting the soil, and (optionally) installing reinforcing landscape fabric or other reinforcing means. The filled surface behind the wall provides a working surface for installers and equipment (such as a skid loader or the like) to install the next few courses. This process of installing and backfilling is repeated until the wall reaches its final, desired height.

OSHA and other safety protocols require safety measures to protect personnel from falling from the wall upon the wall reaching a specified height, such as 6 feet.

Personnel safety measures include a barrier capable of withstanding a specified horizontal force applied at a specified height, a harness system for the installer that is anchored to large block set back from the wall, and the like.

### SUMMARY OF THE INVENTION

A retaining wall formed of man-made retaining wall blocks comprises: plural courses of retaining wall blocks, plural posts, and plural post fixtures. The courses of retaining wall blocks include at least an upper course and a lower course, the retaining wall blocks of the upper course being laterally offset from the retaining wall blocks of the lower course. Each one of the retaining wall blocks has: (i) a body, a front face, a rear face, a top face, and a bottom face that is opposite the top face; each body forming one or more pockets therein; and (ii) an aperture formed in the retaining block body and extending through the top face and the bottom face. The posts extend through the apertures of the upper course of retaining wall blocks and extend into the pockets of the lower course of retaining wall blocks on which the upper course is installed. The post fixtures are located in the pockets such that the fixtures receive the posts; the fixtures being configured to support lower portions of the posts, whereby the plural posts form a personnel barrier at the retaining wall.

Each retaining wall block may include a locking protrusion located on one of the top face and the bottom face and a locking recess located on the other one of the top face and the bottom face; the locking protrusions and the locking recesses configured to mutually engage upon installation of courses of retaining wall blocks. Preferably, each retaining wall block includes locking members, such as. Other means to retain or lock courses of retaining wall blocks, such as pins, may be employed.

Preferably, the fixtures engage surfaces of the pockets to support the lower portions of the post, which may be conventional rebar and may be removable from the fixtures and the apertures, thereby dismantling the personnel barrier as needed. Preferably, the poses are approximately vertical, consistent with the purpose or providing a personnel barrier.

According to another aspect of the present disclosure, a method of forming a personnel barrier at a retaining wall during construction of the retaining wall comprises the steps of: laying plural courses of retaining wall blocks including laying an upper course of retaining wall blocks on a lower course of retaining wall blocks, the upper course being laterally offset from the lower course; each one of the retaining wall blocks having a body and pockets formed by the body, the body having an aperture formed from an upper surface of the body to the lower surface of the body; and inserting posts through the apertures of the retaining wall blocks of the upper course; the posts extending upwardly relative to the upper course and extending downwardly into fixtures located in the pockets of the lower course such that the fixtures support a lower portion of the posts. In this regard, the plural posts form a personnel barrier at the retaining wall.

As explained above, preferably the posts are approximately vertically oriented rebar and the apertures are cylindrical through-holes oriented vertically, such that the method may include the step of inserting the fixtures into the pocket, and may include the steps of removing at least one post from the upper course of retaining wall blocks, then installing at least one retaining wall block in a new course that is on top of the upper course, and then inserting the at least one post in the aperture of at least one retaining wall block of the new course. Preferably, the fixtures contact surfaces of the bodies of the block that define the pockets. Upon reinsertion of the posts, the barrier wall may retain its function of personnel safety while the wall is constructed.

According to another aspect of the present disclosure, a retaining wall block for forming a mortarless retaining wall includes: a body, a front face, a rear face, a top face, and a bottom face that is opposite the top face; the body forming one or more pockets therein, the body defining a pair of wings on which the rear face is formed; and a locking protrusion located on one of the top face and the bottom face and a locking recess located on the other one of the top face and the bottom face; the locking protrusion and the locking recess being located and configured such that the locking protrusion of a first block engages the locking recess of a second block when the retaining wall blocks are installed in courses; wherein: each one of the pair of wings has a split line formed therein, the split line providing a weakening in the corresponding wing enabling a distal portion of the wing to be broken away at the split line, thereby shortening the lateral dimension of the rear face of retaining wall block; the body has a through-hole formed therein through the top face and the bottom face; and the body is configured such that the through-hole of an upper course retaining wall block is in-line with the pocket of a lower course retaining wall block when the locking protrusion is engaged with the locking recess, thereby enabling a post to be inserted through the through-hole of the upper course retaining wall block and into the pocket of the lower course retaining wall block. Preferably, the through-hole is sized to receive rebar.

Preferably, the lateral dimension of the rear face is approximately equal to the lateral dimension of the front face such that the block has a rectangular footprint; and the retaining wall block, after shortening the rear face of the block by breaking at the split line, is adapted for forming convex retaining walls.

According to another aspect of the present disclosure, a method for forming a mortarless retaining wall with retaining wall block comprises the steps of: receiving a pallet of retaining wall blocks arranged in rows, each retaining wall block in a row facing the same direction, each retaining wall block having a front face and a rear face, the front face having a lateral dimension that is the same as the lateral dimension of the rear face; transporting the pallet of retaining wall blocks to a desired location of the retaining wall having an existing course of retaining wall blocks; lifting a first row of retaining wall blocks via a crane and aligning the orientation of the front faces of the first row with the orientation of the front faces existing course of retaining wall blocks; placing the first row of retaining wall blocks onto the existing course of retaining wall blocks; lifting a second row of retaining wall blocks via the crane and aligning the orientation of the front faces of the second row with the orientation of the front faces the existing course of retaining wall block; and placing the second row of retaining wall blocks onto the existing course of retaining wall blocks adjacent the first row.

The step of transporting the pallet of retaining wall blocks may include transporting the pallet via a retaining wall block carrier vehicle. The crane may be integral with the transport machine, which may hydraulic power, electric power, or the like that actuates the crane. A person may control the lifting and placing steps via a controller.

Preferably, crane has the capability to rotate the row at least 180 degrees, or at least 90 degrees. The crane may be of any type, such as an articulating jib crane or a cantilever and a hoist.

According to another aspect of the present disclosure, a wall-block installation vehicle for assembling retaining wall block into a retaining wall comprises: a carrier vehicle, such as a forklift, front end loader, or the like, adapted for picking-up and carrying a pallet of retaining wall block, the carrier vehicle including a power source, such as hydraulic or electric; and a crane coupled to the carrier vehicle and powered by the carrier vehicle power source, the crane adapted for (i) lifting a first row of retaining wall blocks, (ii) aligning the orientation of the front faces of the first row with the orientation of the front faces existing course of retaining wall blocks, and (ii) placing the first row of retaining wall blocks onto the existing course of retaining wall blocks.

The vehicle also may have the capability of lifting a second row of retaining wall blocks via the crane and aligning the orientation of the front faces of the second row with the orientation of the front faces the existing course of retaining wall block; and placing the second row of retaining wall blocks onto the existing course of retaining wall blocks adjacent the first row.

According to another aspect of the present disclosure, a method for forming a retaining wall block comprises the steps of: providing a mold including (i) a first configuration for forming a contiguous retaining wall block pair and (ii) a second configuration for forming a first retaining wall block and a second retaining wall block that is spaced apart from the second retaining wall block, pouring a masonry mix, such as a concrete mix, into the mold; and after the masonry mix sets in the mold, removing the divider plate from between the first retaining wall block and the second retaining wall block.

Preferably, the first retaining wall block is the retaining wall block described above and the second retaining wall block is the retaining wall block described above.

According to another aspect of the present disclosure, a mold for receiving a masonry mix to form a pair of retaining wall blocks includes: a mold body defining a cavity; the mold body having (i) a first configuration for forming a contiguous retaining wall block pair and (ii) a second configuration for forming a first retaining wall block and a second retaining wall block that is spaced apart from the second retaining wall block; and divider plate that, in the second configuration, separates the first retaining wall block from the second retaining wall block. The first retaining wall block is the retaining wall block described above and the second retaining wall block is the retaining wall block described above

### BRIEF DESCRIPTION OF THE FIGURES

FIG. 1 is a top, front perspective view of an embodiment of the retaining wall block.

FIG. 2A is a side view of a retaining wall block of FIG. 1 installed on another retaining wall block to illustrate a protrusion of the lower block engaging a recess in the lower block;

FIG. 2B is a schematic side view of a retaining wall formed of retaining wall blocks and illustrating posts extending from an uppermost course of block, and illustrating the posts extending through the uppermost course of blocks and the next lower course of blocks, and illustrating fixtures installed into pockets of the lower course of blocks;

FIG. 2C is a schematic front view of three courses of retaining wall blocks illustrating the posts and fixtures illustrated in FIG. 2B.

FIG. 3 is a perspective view of a pair of retaining wall blocks illustrating the orientation of the retaining wall blocks during casting;

FIG. 4 is a top view of the pair of retaining wall blocks of FIG. 3.

FIG. 5 is a side elevation view of the pair of retaining wall blocks of FIG. 3.

FIG. 6 is a perspective view of another embodiment pair of retaining wall blocks illustrating the orientation of the retaining wall blocks during casting.

FIG. 7 is a top view of the pair of retaining wall blocks of FIG. 6.

FIG. 8 is a side elevation view of the pair of retaining wall blocks of FIG. 6.

FIG. 9 is a schematic illustration of a fixture configured to be located in a pocket of the retaining wall block.

FIG. 10 is a perspective view of a brick pair and a portion of a mold for making the embodiment retaining wall block of FIG. 1 and/or the embodiment retaining wall block.

FIG. 11 is a view of the mold bottom for the forming the embodiments(s) of FIG. 10.

FIG. 12 is a schematic representation of a vehicle for carrying pallets of retaining wall blocks.

FIG. 13 is a schematic view of a portion of a crane system that is part of the vehicle of FIG. 12.

FIG. 14 is a perspective view of a configuration of retaining wall blocks that may be employed with a method of forming a retaining wall.

### DETAILED DESCRIPTION

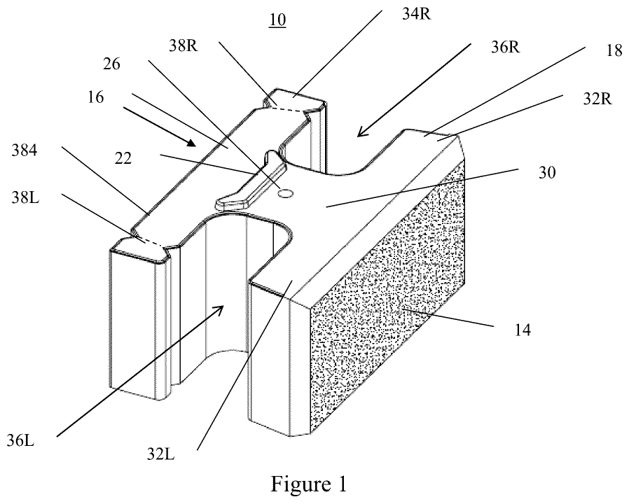

FIG. 1 illustrates a retaining wall block 10 of the type that may be installed together to form a mortarless retaining wall. Block 10 in the embodiment of the figures includes a body 12, a front face 14, a rear face 16 opposite the front face 14, a top face 18, and a bottom face 20 opposite top face 18. Body 12 includes a core 30 roughly in the center of the block 10 and a pair of laterally extending front wings 32L and 32R and a pair of laterally extending rear wings 34L and 34R that extend from core 30.

Front face 14 is formed on the outboard side of front wings 32L and 32R. Block rear face 16 is formed on the outboard side of rear wings 34L and 34R. The term “front” refers to the direction facing the visible portion of retaining block wall. The term “rear” refers to the direction of a retaining block wall facing the fill opposite the visible portion. The terms “rear” and “front” are intended to be helpful in identifying portions of the block, and are not intended to be otherwise limiting unless stated in the claims.

In the embodiment of the figures, the left front and rear wings 34L and 34L are spaced apart to form a pocket 36L therebetween; the right front and rear wings 34R and 34R are spaced apart to form a pocket 36R therebetween. The pockets 36L and 36R are open on their outboard sides and are bounded by core 30 on their inboard sides. Block 10, in the embodiment of the figures, has a rectangular footprint or envelope-that is, the width or lateral dimension defined by the front wings 32L and 32R is approximately equal as the width or lateral dimension of the rear wings 34L and 34R.

Each block has an aperture 26 formed in body core 30. Aperture 26 preferably is an approximately vertical through-hole that extends through top face 18 and bottom face 20 such that a post 40 can be inserted entirely through block 10 via aperture 26, as explained more fully below. In the embodiment of the figures, each post 40 is a piece of conventional rebar, preferably 0.75 inch or 0.6025 inch rebar. Other materials and/or rebar of other dimensions may be used.

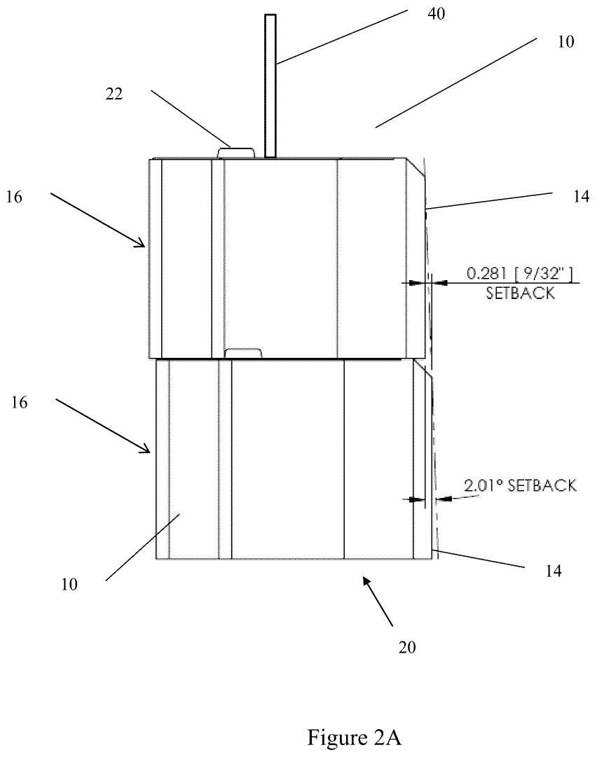

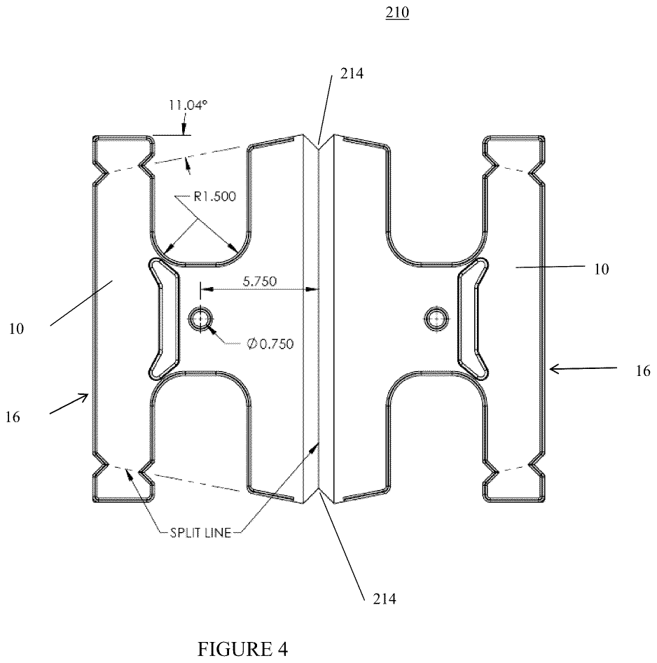

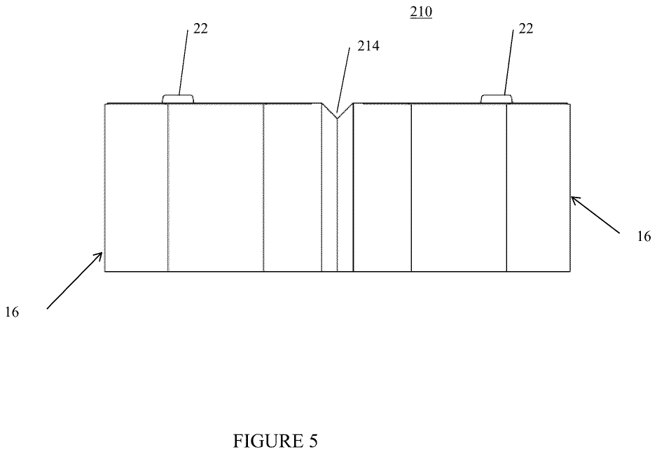

A protrusion 22 extends from top face 18 of the block. Protrusion 22 has a shape referred to as a “dog bone” shape and includes a flat front face (in top view) and a pair of lobes on the rear face. Protrusion 22 tapers such that its upper end has a smaller dimension than its dimension as its base (that is, the protrusion 22 is upwardly tapered), as shown for example in FIG. 5. The position of protrusion 22 controls the magnitude of the set-back of an upper block relative to the lower block on which the upper block is set, which setback is illustrated in FIG. 2B. The set-back is sometimes referred to as “batter.” In the embodiment of the figures, the setback is 0.281 inches ( 9/32nds inch). The present invention is not intended to be limited to magnitude of batter, the shape or position of the protrusions and corresponding recesses, or even the presence of protrusions and recesses, as other locking mechanisms, such as pins and the like, may be employed.

In the embodiment of the figures, each block 10 includes a left split line 38L and a right split line 38R, each illustrated by dashed lines in FIG. 1, that form a weakened region in corresponding rear wings 34L and 34L. The split lines 38L and 38R enable block 10 to maintain a rectangular footprint (that is, in the configuration shown in the figures) for forming into straight and/or convex (that is, outwardly curved) retaining walls and, upon fracturing the block 10 about each split line, to reduce the lateral dimension of the rear wings 34L and 34R for forming the blocks into concave (that is, inwardly curved) retaining walls, as will be understood by persons familiar with retaining wall construction.

FIG. 2C schematically illustrates three rows or courses 111a, 111b, and 111c of blocks 10 of a retaining wall 110. Each course is laterally offset from its adjacent course by one-half block, sometimes referred to as a running bond. Other configurations of blocks may be employed. In the configuration of FIG. 2C, protrusions 22—especially the lobes—are positioned to contact or restrain an inboard surface of the right rear wing 34R of one block 10 and the left rear wing 34L of an adjacent block. In this regard, when installing a new course of block 10 on an existing course in a running bond pattern, roughly one half of a protrusion 22 of an existing block 10 will be in contact with one block 10 of the new course and the other half of the protrusion 22 on the existing block will be in contact with an adjacent block 10. It is understood that wall 110 is not limited to three courses and is limited in height only by practical construction factors.

The running bond configuration also positions aperture 26 of an upper course 11la at the joint or interface between blocks in the lower course 11b and aligns aperture 26 with pockets 36L of a first block and 36R of an adjacent block. The pocket formed by the contiguous opening formed by pockets 36L and 36R is referred to herein as the contiguous pocket 37, which is illustrated by the dashed lines in FIGS. 2B and 2C.

FIGS. 2B and 2C schematically illustrate post 40 extending through aperture 26 upwardly from the upper course 11la of blocks 10 to form at least part of a personnel barrier. In this regard, falls represent a significant risk of injury during retaining wall construction. As the height of the retaining wall increases, one means for meeting safety requirements is a personnel barrier for protecting has falls. Retaining wall 110 having posts 40 may enhance worker safety.

To enhance the strength of a personnel barrier created by posts 40, each post 40 may extend fully through upper course 111a and into the contiguous pocket 37. A fixture 44 may be inserted into contiguous pocket 37. Fixture 44 preferably is sized to fill contiguous pocket 37 and includes an aperture 46. Fixture 44 is configured such that when fixture 44 is inserted in contiguous pocket 37, fixture aperture 46 is aligned block aperture 26. As illustrated schematically in FIGS. 2B and 2C, post 40 may be inserted through block aperture 26 and fixture aperture 46. The contact between the surfaces of fixture 44 and the surfaces of contiguous pocket 37 (that is, the inboard surfaces of right front wing 32R, right rear wing 34R, left front wing 32L, and right front wing 34R.

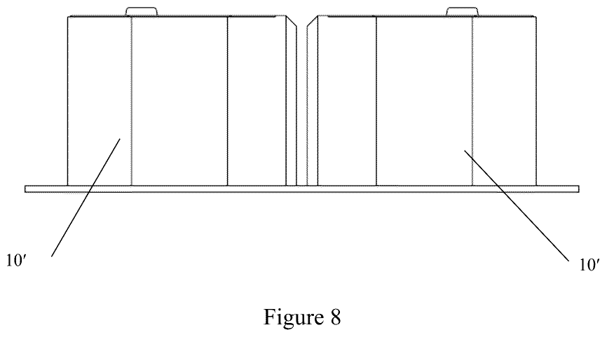

FIG. 9 illustrates an example of a fixture 44. In the embodiment of FIG. 9, fixture 44 has a body that is configured and sized to be inserted into contiguous pocket 37 such that the front and rear faces of fixture 44 contact the corresponding front and rear internal faces of block 10 that define the front and rear sides of contiguous pocket 37, and lateral faces of fixture 44 contact corresponding faces of core 30 that define the lateral sides of contiguous pocket 37. Thus, fixtures 44 are held in place in pockets 37, as illustrated in dashed lines in FIGS. 2B and 2C.

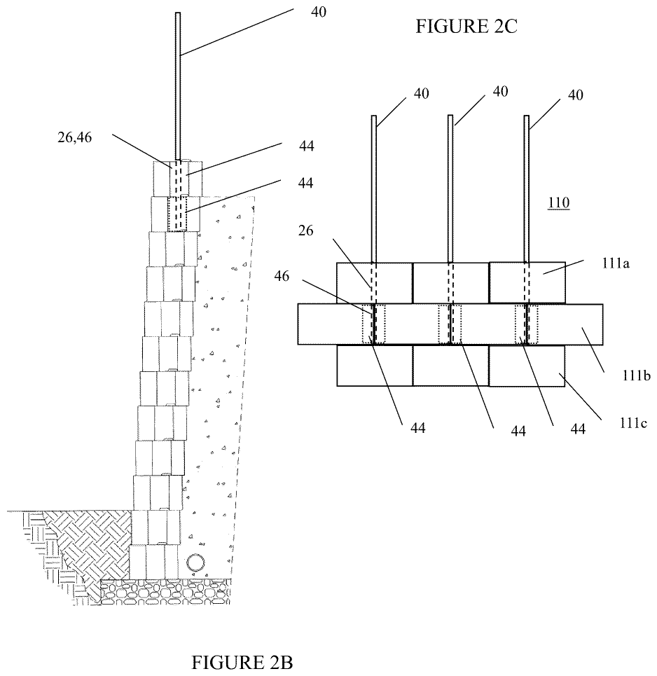

FIGS. 3 through 5 illustrate a first embodiment pair 210 of blocks 10 in the state immediately upon casting. As illustrated, block pair 210 is cast as a single continuous body unit that includes a bevel 214 at the mid-line. The block pair may be split at a split line 230 defined between corresponding bevels 214 to provide the natural appearance of a “split face,” as illustrated by the front face 14 of FIG. 1. Typically, block pair 210 is formed in a mold (described below), after which the mold is removed and the green block pair is heated to conventional curing temperatures in a kiln. After the kiln process, the block pair 210 may be split into blocks 10.

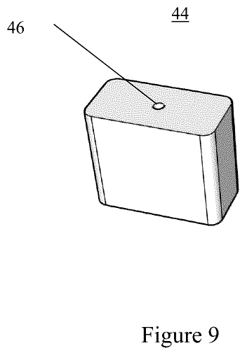

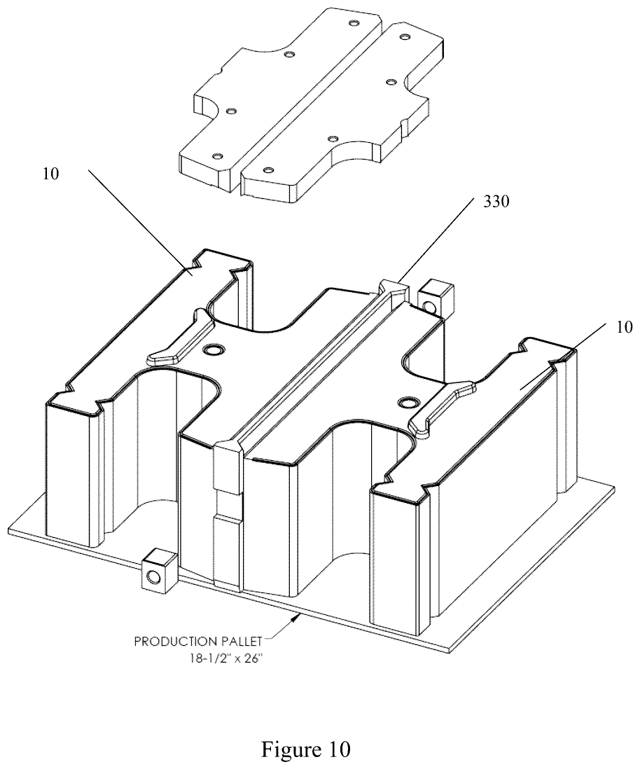

According to another aspect of the disclosure, a mold 310 for forming retaining wall blocks includes a mold body 312 and an optional divider plate 330. Referring to FIGS. 10 and 11, mold body 312 defines a cavity that is configured for receiving a masonry mix, such as a concrete mix, for forming retaining wall blocks, such as block 10 and/or pair 210 described above. Mold body 312 includes sidewalls 320 that define the cavity. Preferably, mold 310 is formed of known structures and materials, as will be understood by persons familiar with retaining block molds and corresponding methods.

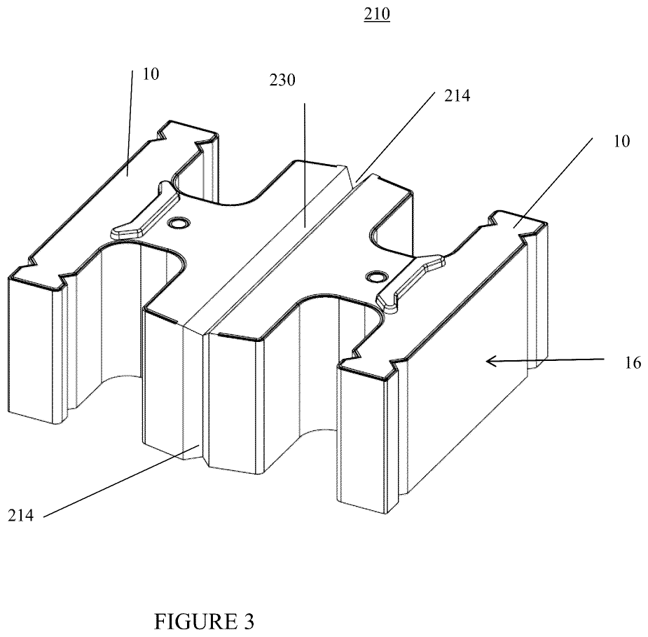

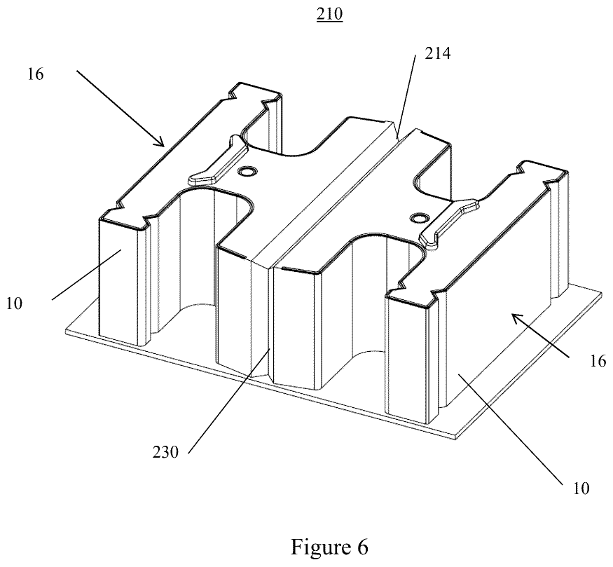

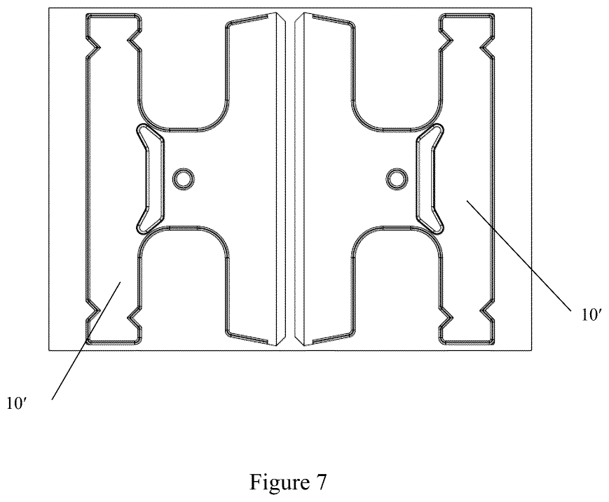

Mold 310 has the capability of forming two, spaced-apart, discrete blocks 10′ (illustrated in FIGS. 7 and 8) and also of forming a contiguous block 210, depending on whether the divider plate 330 is employed. In a first configuration, the cavity of mold 310 is undivided such that pouring a concrete mix into the cavity forms block pair 210 best illustrated in FIG. 4.

Referring to FIG. 10, a second configuration includes divider plate 330 that spans the width of mold 310 to divide the cavity into two separate, non-contiguous spaces. In the second configuration, after sufficient curing or setting of the masonry mix, divider plate 330 may be removed to yield a pair of spaced apart blocks. Thus, a single mold may produce a contiguous block 210 by omitting divider plate 330, such as to produce blocks 10 having a natural stone appearance on its front face, or may produce a pair of discrete blocks 10′, such as to produce a desired texture (according to the choice of surface texture on the face of the divider plate 330) on its front face. The term “pour” and related words refer broadly to encompass flow by gravity, injecting under pressure, and other processes.

The term “discrete” when referring to a block means separate, spaced-apart, and not contiguous. The reference number 10′ refers to a block that is formed employing divider plate 330. Because block 10′ is not formed by splitting a contiguous pair, a front face of block 10 will not have the “split face” surface described above. The same surface as formed by splitting may be formed by forming the surface features into the faces of divider plate 330. Various other surface types may be formed on the front face of block 10′, such as a smooth face, vertical features such as ribs (which enables removal of the mold or block before the block fully sets up in the mold), horizontal features, and the like.

FIG. 11 is a bottom view of mold 310 that includes a pair of opposing block liners 340, which are spaced apart by a v-liner 342, to form block 10 and/or block 10′ described herein. Features of the retaining wall block 210 are shown in the corresponding mold structures, as will be understood by persons familiar with wall block manufacturing.

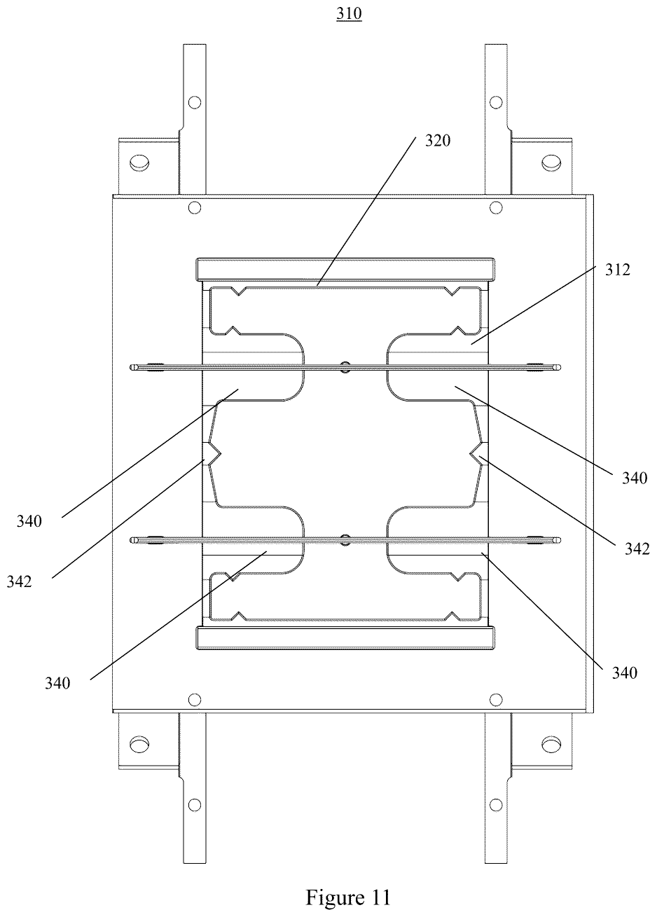

FIG. 12 is a schematic representation of a vehicle for 420 that may be employed for transporting retaining wall blocks 10. Vehicle 410 may be employed in a system for automating building retaining wall 110. Vehicle 410 preferably is a modified or augmented version of a conventional vehicle, such as a skid steer or other loader, a forklift, and the like, without limitation. FIG. 12 illustrates vehicle 410 including forks 422 for engaging a pallet and hydraulic motor system 450 for actuating the forks and other mechanisms of the loader.

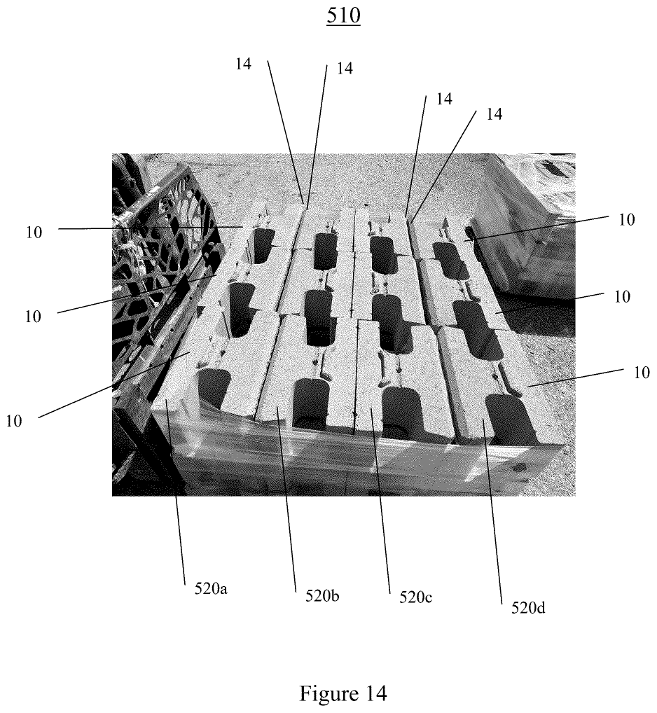

Vehicle 410 also includes a crane system 430, which may encompass any type of crane. For example, crane system 430 may include a mast 432 that is affixed to vehicle 410 by a pair of pivots 442. In the embodiment of FIG. 12 and as partially illustrated in FIG. 14, mast 432 is rigidly connected to a boom 434 such that mast 432 and boom 434 pivot together about pivots 442 in an L-shape configuration. An arm 436 is affixed to the distal end of boom 434 via a boom pivot 444.

FIG. 12 schematically illustrates a hydraulic boom actuator 452 that rotates or pivots mast 432 and boom 434 about a vertical axis defined by pivots 444. A hydraulic arm actuator 454 is configured to pivot arm 436 about arm pivot 444. A hoist 460 is positioned at a distal end of arm 436.

A gripper 470, located at the distal end of chain or arm of hoist 460, includes a pair of opposing fingers 462 located at a distal end of gripper arms 464, a pivot mechanism 466, and a gripper actuator 468. Fingers 462 are capable of grasping a retaining wall block and/or (preferably) a row of multiple retaining wall blocks 10. For example, arms 464 may be configured in a scissor configuration such that moving the proximal (that is, upper) portion of the arms apart creates a corresponding inward force to squeeze fingers 462 against block 10.

Gripper pivot mechanism 466 enables the gripper arms 464 to be rotationally positioned, such as by rotating arms 464 about a vertical axis by at least 180 degrees in a clockwise direction and a counterclockwise direction. Alternatively, gripper arms 464 may be rotatable by less than 180 degrees, such as less than 120 degrees, or less than 105 degrees while preferably being rotatable by at least 90 degrees. Gripper actuator 468 both rotates the arms 464 and provides the force to the arms 464 to grasp a retaining wall block or row of blocks. A controller, which may be handheld or located on the console of vehicle 410, may be employed by a user to control each function of crane system 430, such that a user determines the placement of each block and/or array of blocks on griper arms 464.

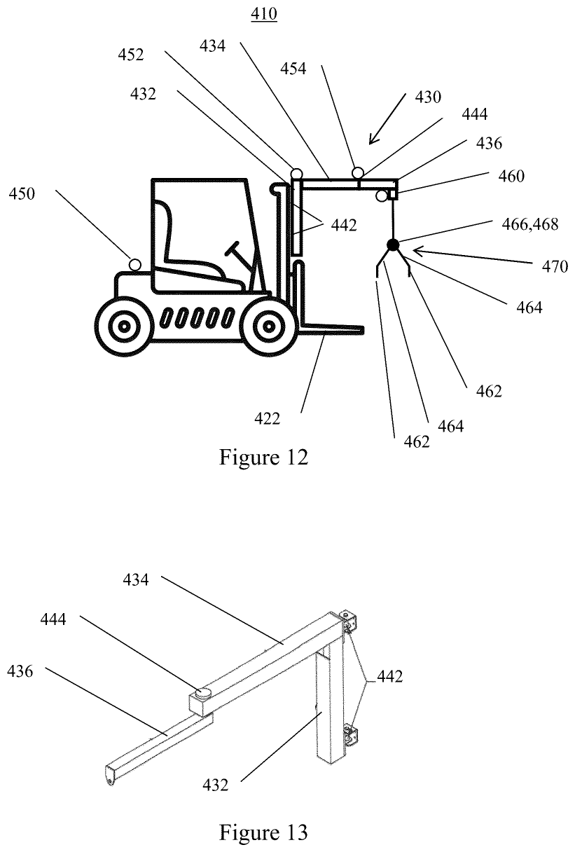

FIG. 13 illustrates a configuration of a pallet 510 of wall blocks 10 that may be employed in a process of automating the forming of a retaining wall. Several layers of retaining wall blocks may be configured on the pallet, according to well-known weight and size factors.

In the embodiment of the FIG. 13, four rows 520a, 520b, 520c, and 520d of three retaining wall blocks 10 are configured on a pallet (not shown). Each row has its split face facing the same direction, with the split faces of rows 520a and 520b facing each other, and the split faces of rows 520c and 520d facing each other.

In operation, pallet 510 may be transported from a delivery location to the wall site via vehicle 410. At the site, gripper mechanism 466 may engage a first row, for example row 520a, such that fingers 462 grasp opposing ends of the three-block row of retaining wall blocks. The inventors surmise that speed and ease of installation is enhanced by the configuration of rows 520a through 520b. In this regard, upon grasping a first row or retaining wall blocks, pivot mechanism 466 may position the row in the desired face orientation and lower the row into place, such as by employing hoist 460. Then, gripper 470 may engage, lift, and place another row of blocks, such as row 520b. Because of the orientation of the block faces on the pallet rows, pivot mechanism 466 in some configurations requires only the capacity to pivot 90 degrees in a clockwise orientation and 90 degrees in a counterclockwise orientation, if vehicle 410 is positioned parallel to the retaining wall. Some capacity of rotation more than 90 degrees is desirable in case of vehicle 410 is position nearly parallel.

The term “mortarless” and/or “mortarless retaining wall” are employed to describe a broad type of block that may be employed to form a retaining wall by laying courses of retaining wall block mostly free of mortar or grout. The term(s) distinguish a natural stone wall requiring a skilled mason, but encompasses all manner of man-made blocks and encompasses blocks and block walls employing adhesives.

The present invention is not limited by the particular structure, dimensions, and/or configurations described above. Structures and their corresponding functions and methods are described merely for example. Rather, the scope of the invention is intended to be interpreted by the wording of the claims

1. A retaining wall formed of man-made retaining wall blocks, the retaining wall comprising:
plural courses of retaining wall blocks including at least an upper course and a lower course, the retaining wall blocks of the upper course being laterally offset from the retaining wall blocks of the lower course; each one of the retaining wall blocks having:
a body, a front face, a rear face, a top face, and a bottom face that is opposite the top face; each body forming one or more pockets therein; and
an aperture formed in the retaining block body and extending through the top face and the bottom face;
plural posts, the posts extending through the apertures of the upper course of retaining wall blocks and extending into the pockets of the lower course of retaining wall blocks on which the upper course is installed; and
plural post fixtures, the fixtures located in the pockets such that the fixtures receive the posts;
the fixtures being configured to support lower portions of the posts;
whereby the plural posts form a personnel barrier at the retaining wall.

2. The retaining wall of claim 1 wherein each retaining wall block includes a locking protrusion located on one of the top face and the bottom face, the locking protrusions being configured to engage corresponding surfaces of adjacent retaining wall blocks upon installation of courses of retaining wall blocks.

3. The retaining wall of claim 1 wherein the fixtures engage surfaces of the pockets to support the lower portions of the post.

4. The retaining wall of claim 1 wherein the posts are rebar.

5. The retaining wall of claim 1 wherein the posts are removable from the fixtures and the apertures, thereby dismantling the personnel barrier for enabling installation of another course of retaining wall block.

6. The retaining wall of claim 1 wherein the apertures are cylindrical through-holes oriented approximately vertically and the posts are approximately vertical.

7. A method of forming a personnel barrier at a retaining wall during construction of the retaining wall, comprising the steps of:
laying plural courses of retaining wall blocks including laying an upper course of retaining wall blocks on a lower course of retaining wall blocks, the upper course being laterally offset from the lower course; each one of the retaining wall blocks having a body and pockets formed by the body, the body having an aperture formed from an upper surface of the body to the lower surface of the body, and
inserting posts through the apertures of the retaining wall blocks of the upper course; the posts extending upwardly relative to the upper course and extending downwardly into fixtures located in the pockets of the lower course such that the fixtures support a lower portion of the posts;
whereby the plural posts form a personnel barrier at the retaining wall.

8. The method of claim 7 further comprising the steps of removing at least one post from the upper course of retaining wall blocks, then installing at least one retaining wall block in a new course that is on top of the upper course, and then inserting the at least one post in the aperture of at least one retaining wall block of the new course.

9. The method of claim 7 further comprising the step of inserting the fixtures into the pockets.

10. The method of claim 7 wherein the fixtures contact surfaces of the bodies that define the pockets.

11. A retaining wall block for forming a mortarless retaining wall, the retaining wall block comprising:
a body, a front face, a rear face, a top face, and a bottom face that is opposite the top face; the body forming one or more pockets therein, the body defining a pair of wings on which the rear face is formed; and
a locking protrusion located on one of the top face and the bottom face and a locking recess located on an other one of the top face and the bottom face; the locking protrusion and the locking recess being located and configured such that the locking protrusion of a first block engages the locking recess of a second block when the retaining wall blocks are installed in courses;
wherein:
each one of the pair of wings has a split line formed therein, the split line providing a weakening in the corresponding wing enabling a distal portion of the wing to be broken away at the split line, thereby shortening the lateral dimension of the rear face of retaining wall block;
the body has a through-hole formed therein through the top face and the bottom face; and
the body is configured such that the through-hole of an upper course retaining wall block is in-line with the pocket of a lower course retaining wall block when the locking protrusion is engaged with the locking recess, thereby enabling a post to be inserted through the through-hole of the upper course retaining wall block and into the pocket of the lower course retaining wall block.

12. The retaining wall block of claim 11 wherein the lateral dimension of the rear face is approximately equal to the lateral dimension of the front face such that the block has a rectangular footprint.

13. The retaining wall block of claim 12 wherein the retaining wall block, after shortening the rear face of the block by breaking at the split line, is adapted for forming convex retaining walls.

14.-23. (canceled)
